(19) United States
(12) Patent Application Publication
(10) Pub. No.: US 2010/0242436 A1
(43) Pub. Date: Sep. 30, 2010

(54) MODULATION OF INLET MASS FLOW AND RESONANCE FOR A MULTI-TUBE PULSE DETONATION ENGINE SYSTEM USING PHASE SHIFTED OPERATION AND DETUNING

(75) Inventors: Venkat Eswarlu Tangirala, Niskayuna, NY (US); Adam Rasheed, Glenville, NY (US); Narendra Digamber Joshi, Schenectady, NY (US); James Fredric Wiedenhoefer, Clifton Park, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/415,677

(22) Filed: Mar. 31, 2009

(51) Int. Cl. F02K 5/02

(52) U.S. Cl. 60/247

(57) ABSTRACT

An engine contains a compressor stage, a plurality of pulse detonation combustors and a plurality of inlet valves, where the inlet valves direct a mass flow into the pulse detonation combustors. A control system controls at least one of a phase shift, firing frequency and a τₒₚₑₙ/τ_{cycle} ratio of the pulse detonation combustors based on a mass flow and/or a resonance within the engine.

### BACKGROUND OF THE INVENTION

This invention relates to pulse detonation systems, and more particularly, modulation of inlet mass flow and resonance for a multi-tube pulse detonation engine system using phase shifted operation and detuning.

With the recent development of pulse detonation combustors (PDCs) and engines (PDEs), various efforts have been underway to use PDC/Es in practical applications, such as in aircraft engines and/or as means to generate additional thrust/propulsion or in ground based power generation. It is noted that the following discussion will be directed to “pulse detonation combustors” (i.e. PDCs). However, the use of this term is intended to include pulse detonation engines, and the like.

Because of the recent development of PDCs and an increased interest in finding practical applications and uses for these devices, there is an increasing interest in implementing PDCs in commercially and operationally viable platforms. Further, there is an increased interest in using multiple PDCs in a single engine or platform so as to increase the overall operational performance. However, because of the nature of their operation, the practical use of multiple PDCs is often limited by some of the operational issues they present. These issues include mass flow management from upstream components, such as a compressor, and the generation of resonant frequencies on downstream components, such as a turbine.

For example, during certain operational conditions it is possible to experience an unbalanced mass flow of air flow (as an example) between an inlet flow, such as through a compressor, and the inlets of the PDCs. That is, the mass flow consumed by the PDCs during operation is less than the mass flow entering the system as a whole. Because of this, flow oscillations can be experienced in the components upstream of the PDCs which can adversely affect the performance and operation of the PDCs.

An additional issue is the creation of resonance in downstream components due to the pulsed operational nature of downstream components. For example, if a plurality of PDCs are arranged in a circular pattern, they are fired sequentially in a clockwise direction. However, the sequential firing of multiple PDCs can result in creating resonance in downstream components of an engine. The creation of this resonance can result in high cycle fatigue failure in downstream components. Additionally, when one off-axis PDC tube is fired at a time this can create large flow asymmetries can lead to losses downstream as the flow passes through nozzles, etc. Additionally, force loading on downstream components can be asymmetric, thus requiring additional structure and weight to compensate for this loading.

Therefore, there exists a need for an improved method of firing PDCs so that any resonant frequencies are detuned and engine mass flow is optimized and/or maintained.

### SUMMARY OF THE INVENTION

In an embodiment of the present invention, an engine contains a plurality of pulse detonation combustors, a plurality of inlet valves, wherein each one of the plurality of pulse detonation combustors is coupled to an inlet valve, and a control system. The control system controls at least one of a phase shift, a firing frequency and a τₒₚₑₙ/τ_{cycle} ratio of the pulse detonation combustors based on at least one of a mass flow in the engine and a resonance in the engine. τₒₚₑₙ is the duration of time at least one of the valves is open during an operational cycle of at least one of the pulse detonation combustors and τ_{cycle} is the duration of time for the operational cycle.

As used herein, a “pulse detonation combustor” PDC (also including PDEs) is understood to mean any device or system that produces both a pressure rise and velocity increase from a series of repeating detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs (and PDEs) include a means of igniting a fuel/oxidizer mixture, for example a fuel/air mixture, and a detonation chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, auto ignition or by another detonation (i.e. cross-fire).

As used herein, “engine” means any device used to generate thrust and/or power.

### BRIEF DESCRIPTION OF THE DRAWINGS

The advantages, nature and various additional features of the invention will appear more fully upon consideration of the illustrative embodiment of the invention which is schematically set forth in the figures, in which:

FIG. 1 shows a diagrammatical representation of an engine in accordance with an exemplary embodiment of the present invention;

FIG. 2 shows a diagrammatical representation of an exemplary embodiment of the present invention with four PDCs;

FIGS. 3A and 3B show a diagrammatical representation of PDC firing sequences in accordance with an exemplary embodiment of the present invention; and

FIGS. 4A and 4B show a diagrammatical representation of PDC firing sequences in accordance with another exemplary embodiment of the present invention.

### DETAILED DESCRIPTION OF THE INVENTION

The present invention will be explained in further detail by making reference to the accompanying drawings, which do not limit the scope of the invention in any way.

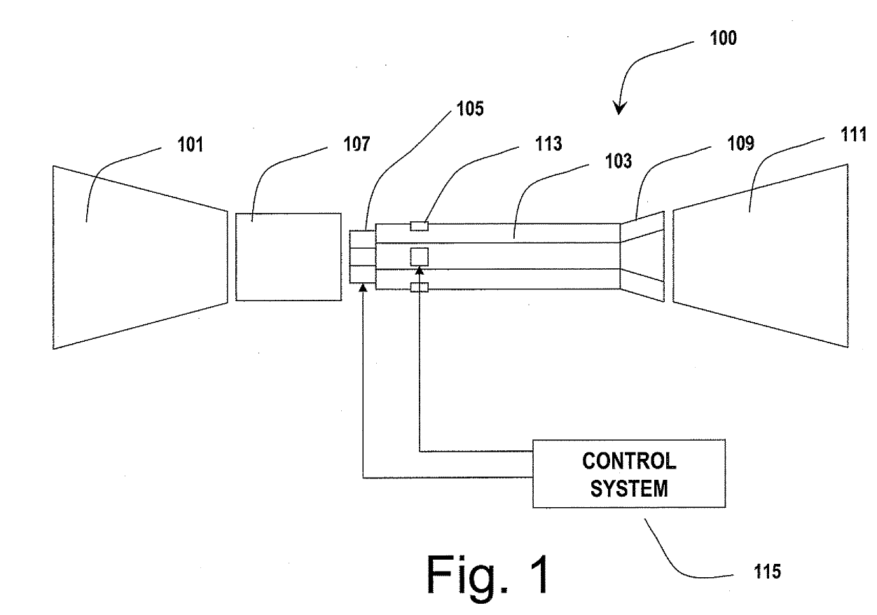

FIG. 1 depicts an engine 100 in accordance with an embodiment of the present invention. As shown, the engine 100 contains a compressor stage 101, a plurality of PDCs 103 and a turbine stage 111. Each of the compressor stage 101, the PDCs 103 and turbine stage 111 can have a conventional and known structure and configuration. The various embodiments of the present invention are not limited in this regard. Coupled to the PDCs are nozzles 109 which direct the flow from the PDCs 103 into the turbine stage 111. As shown in FIG. 1, the nozzles 109 diverging. However, the nozzles 109 can be of the converging or converging-diverging type. Moreover, in the embodiment shown, each PDC 103 is coupled to its own nozzle 109. However, the present invention is not limited to this specific embodiment as it is contemplated that a single nozzle, plenum and/or manifold structure can be used to direct the flow from the plurality of PDCs to the turbine 111.

Between the PDCs 103 and the compressor stage 101 is an inlet system 107 which comprises a plurality of inlet valves 105. The inlet system 107 may include a plenum or manifold structure to deliver flow from the compressor stage 101 to the inlet valves 105. The inlet valves 105 can be of any known or conventionally used inlet valve structure, as PDC inlet valve structures and systems are known, the details surrounding these structures and systems will not be discussed in detail herein, as any known valve structure can be employed without departing from the scope and spirit of the present invention, so long as the valve structure is capable of performing within the desired operational parameters for the engine 100. In an exemplary embodiment of the present invention, each of the valves 105 is a rotating type valve structure. In another exemplary embodiment reciprocating types valves may be employed as an alternative or in addition to rotary type valves.

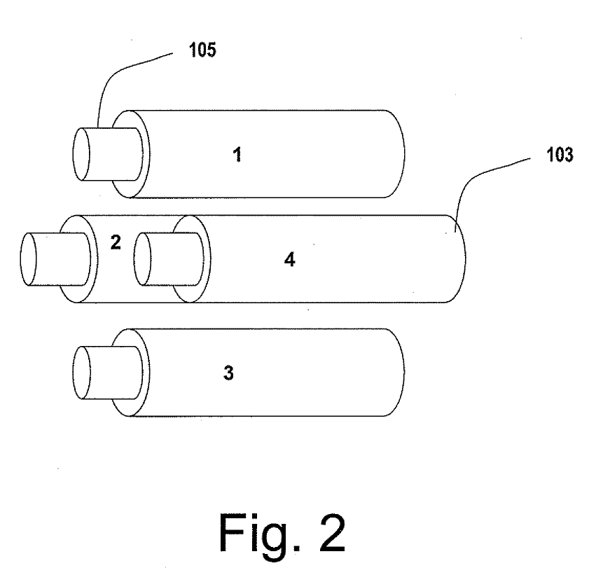

In the exemplary embodiment of the present invention, as shown in FIG. 1 and FIG. 2, each of the PDCs 103 is coupled to its own inlet valve 105. This allows for maximum flexibility of control of the engine 100 and the firing of the PDCs 103. In another exemplary embodiment of the present invention (not shown) the inlet valves 105 have a structure such that they are coupled to more than one, for example two (2), PDCs 103 such that each inlet valve 105 is operationally coupled to more than one PDC 103. In such an embodiment, the valve 105 can provide inlet flow to any one or all of the PDCs 1034 to which it is coupled at a time. It is contemplated that an example of such an embodiment contains eight (8) PDCs 103 and four (4) inlet valves 105, such that two PDCs 103 are operationally coupled to each valve 103. Thus, the valve 105 can direct flow to either one or both of the PDCs 103 to which it is coupled. This can be accomplished using any known flow direction type devices/manifolds.

Coupled to each of the PDCs 103 is an ignition source 113 which is used to initiate the detonation within the PDC 103. The ignition source 113 can be of any known type and the present invention is not limited in this regard.

In an exemplary embodiment, the operation of the PDCs 103 is controlled by a control system 115, which can be any known computer or microcontroller based control system. In the exemplary embodiment shown in FIG. 1, the control system 115 controls the operation of the valves 105 and/or the ignition sources 113 to effect control of the PDCs 103, which will be described in more detail below.

During an operation of the exemplary embodiment of the engine 100 shown in FIG. 1 a mass flow (for example, air) enters the compressor stage 101 and is compressed and directed to the inlet system 107 (which may or may not contain a plenum or manifold structure). This mass flow is then directed, via the valves 105 into the various PDCs 103 during operation so as to provide the compressed mass flow to the PDCs 103 for operation. A fuel can be mixed with the mass flow at any point prior to or within the PDCs 103 to provide the desired fuel-air mixture needed for detonation within the PDCs 103. The present invention is not limited in this regard.

Following detonation, the exhaust is directed out of the PDCs 103 through the nozzles 109 and into a turbine stage 111.

It is noted that in other contemplated embodiments of the present invention, the compressor stage 101 and/or the turbine stage 111 may be replaced with other components depending on the specific application of the engine 100. Further, other embodiments may not employ nozzles 109 but have the exhaust from the PDCs 103 enter a downstream component. Alternatively a plenum or similar structure may be positioned between the PDCs 103 and the downstream component. Further, in yet another exemplary embodiment it is contemplated that the inlet system 107 may be made up only of the valves 105, and will not have a plenum or other structure, such that the mass flow from the upstream component (e.g., the compressor stage 101) is directed directly into the valves 105.

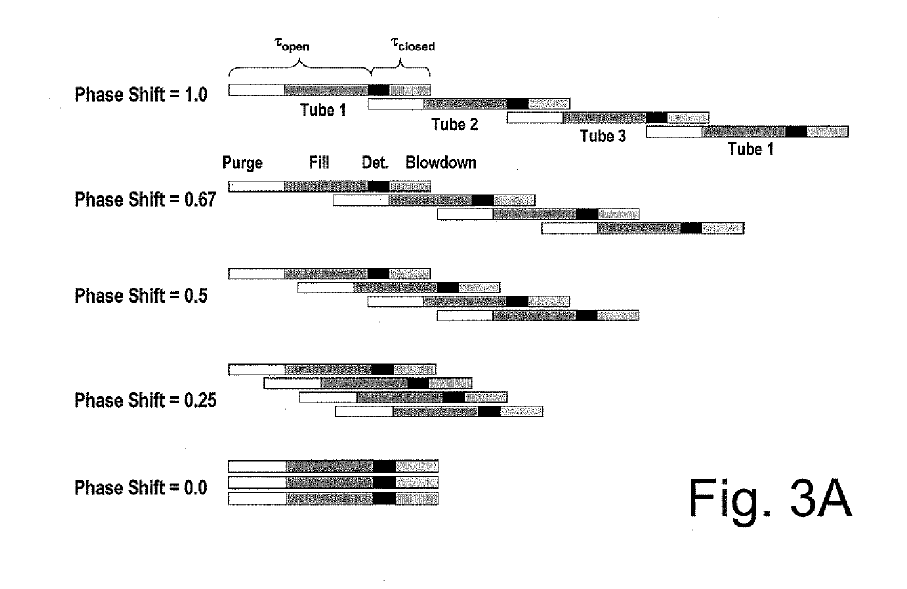

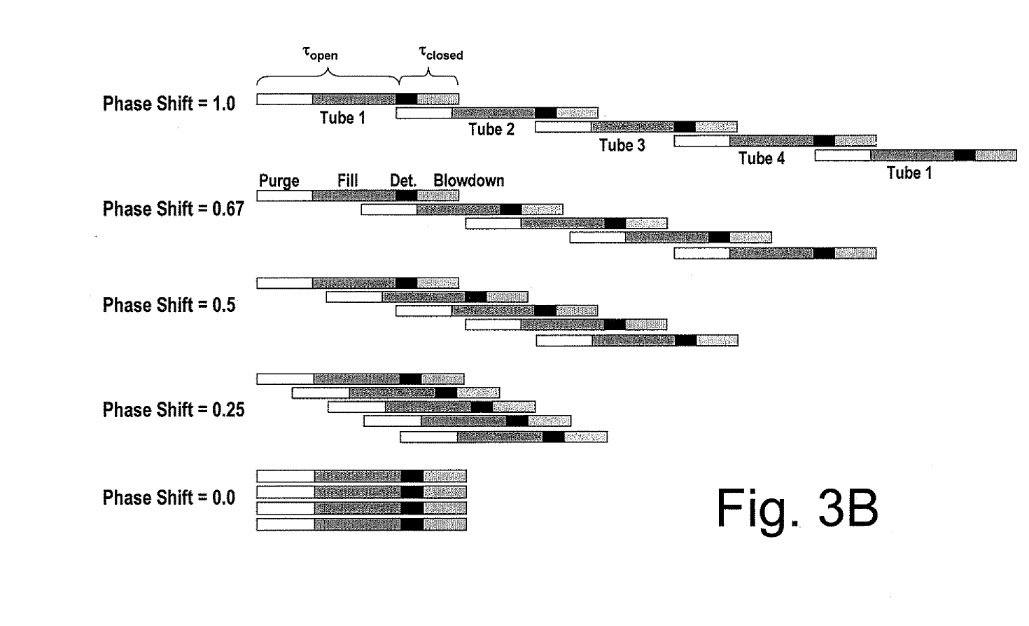

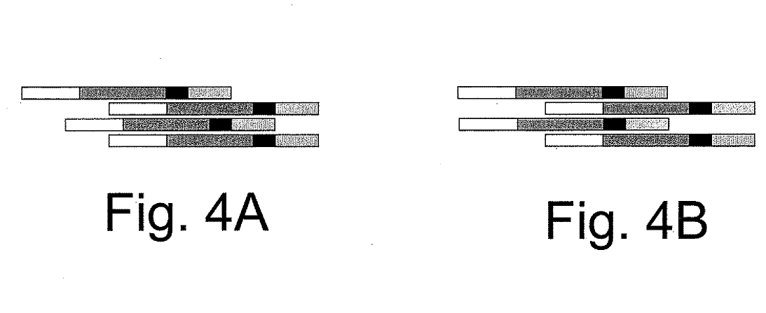

FIG. 2 graphically depicts the PDCs 103 of FIG. 1 in an asymmetric view, where each PDC 103 has an inlet valve 105 coupled to it. In this embodiment, only four (4) PDCs 103 are shown distributed in an annulus arrangement. However, the present invention is not limited to this quantity or arrangement of PDCs 103, that is any number and/or physical arrangement of PDCs 103 can be employed in various embodiments of the present invention. Each of the PDCs 103 are numbered (“1” through “4”) in FIG. 2 to assist in the understanding of FIGS. 3A, 3B, 4A and 4B, which will be explained below.

FIGS. 3A and 3B diagrammatically depict the relative timing of firing of PDCs 103 in an engine according to an embodiment of the present invention so that mass flow through the engine can be optimized. FIG. 3A shows a three PDC system while FIG. 3B depicts a four PDC system (similar to FIGS. 1 and 2). In FIG. 3B the top figure has the respective numbered tubes from FIG. 2 identified to aid in understanding the following discussion. Further, each “bar” shown in the FIGS. 3A and 3B represent a firing cycle of single PDC 103, such that the left most portion of the bar shows the purge time, the adjacent portion represents the fill portion of the cycle, followed by the detonation portion and the blow down portion of the cycle. As is known in the art, these four stages make up a single firing cycle of a PDC. (It is noted that the respective length of the sections of the “bars” shown in FIGS. 3A and 3B are not intended to be to scale with respect to the durations of each of the stages of a firing cycle, but are simply representative as a visual guide.) Further, each of the FIGS. 3A and 3B show a series of figures which depict a relative shift in the firing frequency or timing of the PDCs, which will be discussed in more detail below.

As previously discussed, there is a need to balance the mass flow from the compressor stage 101 and/or the mass flow passing through the engine and the mass flow consumed by the PDCs 103 during operation to eliminate or minimize mass flow oscillations upstream of the PDCs 103. That is, embodiments of the present invention are directed to optimizing the overall mass flow through the engine 100 having PDCs 103 such that the desired engine performance is achieved taking into account the mass flow passing through the engine 100 and any changes in the mass flow. Prior art systems are unable to accomplish this.

Therefore, in an exemplary embodiment of the present invention, a mass flow in the engine 100 and/or the mass flow being directed to the inlet valves 105 is determined. This can be done via various methods, including detection and/or calculation. Based on this determined mass flow the control system 115 controls the valves 105 and/or the ignition sources 113 of the respective PDCs 103 to adjust an operational parameters of the PDCs 103 to change the mass flow through the PDCs 103, as desired.

In an embodiment of the present invention, mass flow may be controlled by altering/controlling the phase shift of the PDCs 103. That is, the timing at which the PDCs are filled/fired with respect to each other is changed such that the overall amount of mass flow passing through the PDCs 103 is increased/decreased as needed. In an exemplary embodiment of the present invention, the phase shift is controlled such that mass flow consumption by the PDCs 103 during operation substantially matches the mass flow in the compressor stage 101 and/or the inlet system 107. By substantially matching mass flow consumption the overall operation of the engine 100 can be optimized to ensure that no oscillations occur in the mass flow upstream of the PDCs 103, or that the PDCs 103 “starve” during operation.

The phase shift between the filling/firing of the PDCs 103 is essentially a percentage time differential between the firing of sequential PDCs 103. This can be seen in FIGS. 3A and 3B, which depict phase shifts of 1.0, 0.67, 0.5, 0.25 and 0.0. This is explained more fully below, however it is noted that in various embodiments of the present invention a phase shift of 0.0 should be avoided, such that the phase shift is between 0.0 and less than or equal to 1.0.

As explained above, typical PDC operation contains four (4) operational steps. They are: (1) purge stage, (2) fill stage, (3) detonation stage, and (4) blow down. During both the purge and fill stages the valve 105 (for a particular PDC 103) is open and closed during the detonation and blow down stages. Thus, the cycle time τ_{cycle} of a PDC can be characterized as the valve open time+the valve closed time (τ_{cycle}=τₒₚₑₙ+τ_{closed}). Thus, having a phase shift of 0.67 (for example) means that the purge stage of a PDC 103 begins 0.67×τₒₚₑₙ after the start of the valve open phase of the preceding PDC 103.

In an embodiment in which phase shifting is employed, the control system 115 will use its various input parameters to determine whether or not the phase shift between PDCs 103 is to be increased or decreased.

As shown in FIGS. 3A and 3B, a phase shift of 1.0 means that the purge stage of a following PDC 103 begins at 1.0×τₒₚₑₙ of the preceding PDC 103. This is shown as the uppermost figure in each of FIGS. 3A and 3B. At a phase shift of 1.0 the mass flow through the PDCs 103 may be at its lowest level, while maintaining a continuous mass flow. Stated differently, at a phase shift of 1.0 only one PDC 103 has a valve 105 open at a given time. Various different phase shift embodiments are shown in FIGS. 3A and 3B.

In FIG. 3A, the figures below the uppermost figure show phase shifts of 0.67, 0.5, 0.25 and 0.0, respectively.

As the phase shift approaches 0.0 (where all PDCs are filling at the same time) the mass flow rate of the PDCs can increase. Thus, a phase shift of 0.0 theoretically provides the maximum mass flow rate for a PDC system during the purge and fill process. However, a phase shift of 0.0 also forces inlet mass flow to halt during the valve closed state since all of the valves are closed. This would cause a flow disruption and, therefore, a phase shift of 0.0 should be avoided in various embodiments of the present invention. Likewise, a phase shift of greater than 1.0 would cause a stoppage of mass flow between the firing of adjacent PDCs. Therefore, for an embodiment of the present invention to operate properly at these conditions, other mechanisms and/or systems may be need to employed with the engine, such as an inlet flow bypass system so as to ensure that upstream flow oscillations are avoided.

In further exemplary embodiments of the present invention, the following relationship can be adhered to ensure operation of the PDCs 103 such that mass flow is properly maintained:

0.0<n*Φ<1.0

Where “n” is the number of PDCs 103 in the bundle and Φ is the ratio of τₒₚₑₙ/τ_{cycle}. This relationship dictates that during operation of the PDC bundle at least one valve/PDC is open at all times and at least one valve/PDC is closed at all times. Thus, the phase shift is less than or equal to 1.0 and greater than 0.0.

In further exemplary embodiments of the present invention, the ratio of the valve open time to cycle time, τₒₚₑₙ/τ_{cycle}, can be used to adjust the mass flow through the PDCs 103. That is the higher the ratio the higher the overall mass flow as the overall time that the valves 105 are open with respect to the cycle time is higher.

Thus, during operation of an exemplary embodiment of the present invention, the control system 115 can adjust the phase shift of the PDCs as well as the ratio of τₒₚₑₙ/τ_{cycle} to ensure that the mass flow being consumed by the PDCs 103 matches the desired engine performance and the mass flow passing through the compressor stage 101 and/or the inlet system 107. As such, embodiments of the present invention can minimize mass flow oscillations in the engine 100 which can be caused by mass flow imbalances within the engine 100.

FIG. 3B depicts similar variations in phase shift in a four (4) PDC 103 system as shown in FIG. 2. FIG. 3B shows the same 1.0, 0.67, 0.5, 0.25 and 0.0 phase shifts as shown in FIG. 3A.

Additional embodiments of the present invention can employ adjustment of the firing frequency of the PDCs 103 to control mass flow through the PDCs 103. The firing frequency, which is essentially the duration of τ_{cycle} can be adjusted (lengthened or decreased) to increase or decrease the overall mass flow rate through the PDCs 103, and thus the engine. In various embodiments of the present invention the firing frequency can be changed in conjunction with or as an alternative to changing the phase shift as discussed above.

In an embodiment in which the firing frequency is changed, the control system 115 controls the operation of the valves 105 and/or ignition sources 113 such that the firing frequency of a given PDC 103 is either increased or decreased as needed. For example, by increasing the firing frequency the overall mass flow of the PDCs 103 is increased as more air (for example) is being consumed in the detonation process. Alternatively, as the frequency is decreased the consumed mass flow is decreased.

Thus, the firing frequency and/or the phase shift and/or τₒₚₑₙ/τ_{cycle} of respective PDCs 103 can be changed/controlled to ensure that the mass flow being consumed by the PDCs 103 during operation ensures proper operation of the engine 100. In an exemplary embodiment of the present invention, the firing frequency and/or the phase shift and/or τₒₚₑₙ/τ_{cycle} ratio is controlled such that mass flow consumption by the PDCs 103 during operation substantially matches the mass flow in the compressor stage 101 and/or the inlet system 107. By substantially matching mass flow consumption the overall operation of the engine 100 can be optimized to ensure that no oscillations occur in the mass flow upstream of the PDCs 103, or that the PDCs 103 “starve” during operation.

In a further exemplary embodiment of the present invention, the phase shift and/or firing frequency and/or τₒₚₑₙ/τ_{cycle} ratio of the PDCs 103 is maintained through the PDC bundle firing cycle. For example, in FIG. 3B the phase shift and/or firing frequency and/or τₒₚₑₙ/τ_{cycle} ratio is maintained throughout the entire cycle of each of the PDCs 1 through 4, and then can be adjusted changed at the beginning of the next firing cycle. However, in other exemplary embodiments, the control system can adjust the phase shift, firing frequency and/or τₒₚₑₙ/τ_{cycle} ratio within the cycle of the PDC bundle.

As shown in both FIG. 3B (and similarly in FIG. 3A), the tubes 1, 2, 3 and 4 are operated sequentially so as to provide a rotational firing pattern (see FIG. 2). However, in another exemplary embodiment of the present invention the firing sequence does not produce a rotational firing pattern, but can be an alternating firing pattern such that no two adjacent PDCs 103 are detonated in sequence. This can be seen in FIGS. 4A and 4B.

In addition to managing mass flow within the engine, exemplary embodiments of the present invention can manage resonance within the engine 100. As previously discussed, the operation of PDCs 103 can generate resonance in engine components, particularly downstream components such as the turbine stage 111. Accordingly, embodiments of the present invention determine or monitor resonance in the engine, and for example the turbine stage, and the control system 115 employs this data to adjust the firing sequence of the PDCs 103 to optimize PDC 103 operation and minimize resonance. To accomplish this, embodiments of the present invention use the control system 115 to control the operation of the valves 105 and the ignition sources 113 to sequence the firing of the PDCs 103 to minimize engine resonance. FIGS. 4A and 4B are examples of detonation sequencing which are implemented to minimize resonance within the engine. In such embodiments, the detonation sequencing would not provide a rotational firing pattern (as would FIGS. 3A and 3B). The firing pattern can be adjusted as needed.

Thus, embodiments of the present invention manage mass flow and resonance detuning of components of the engine 100. For example, the control system 115 controls the valves 105 and/or the ignition sources 113 to ensure that PDC 103 phase shift and firing frequency properly manage engine mass flow and that the order of the firing of the PDCs 103 detunes resonance in the engine 100 and/or downstream components such as the turbine stage 111.

It is noted that although the present invention has been discussed above specifically with respect to aircraft and power generation applications, the present invention is not limited to this and can be in any similar detonation/deflagration device in which the benefits of the present invention are desirable.

While the invention has been described in terms of various specific embodiments, those skilled in the art will recognize that the invention can be practiced with modification within the spirit and scope of the claims.

What is claimed is:

1. An engine, comprising:
a plurality of pulse detonation combustors;
a plurality of inlet valves, wherein each one of said plurality of pulse detonation combustors is coupled to an inlet valve; and
a control system to control the operation of said pulse detonation combustors,
wherein said control system controls at least one of a phase shift, a firing frequency and a τₒₚₑₙ/τ_{cycle} ratio of said pulse detonation combustors based on at least one of a mass flow in said engine and a resonance in said engine, where τₒₚₑₙ is the duration of time at least one of said valves is open during an operational cycle of at least one of said pulse detonation combustors and τ_{cycle} is the duration of time for said operational cycle.

2. The engine of claim 1, wherein said control system controls said phase shift and said phase shift is greater than 0.0 and equal to or less than 1.0.

3. The engine of claim 1, wherein said engine further comprises a compressor stage and said mass flow is received from said compressor stage.

4. The engine of claim 1, wherein said engine further comprises a turbine stage and said resonance is determined from said turbine stage.

5. The engine of claim 1, wherein each of said pulse detonation combustors is coupled to a single of said inlet valves.

6. The engine of claim 1, wherein said control system increases said phase shift to decrease a mass flow through said pulse detonation combustors and decreases said phase shift to increase said mass flow through said pulse detonation combustors.

7. The engine of claim 1, wherein said control system controls the operation of said pulse detonation combustors such that directly adjacent pulse detonation combustors are not operated sequentially.

8. The engine of claim 1, wherein said control system operates said pulse detonation combustors such that the relationship 0.0<n*Φ≦1.0 is maintained during operation of the engine, where “n” is the number of said pulse detonation combustors and Φ is the ratio of τₒₚₑₙ/τ_{cycle}.

9. The engine of claim 1, wherein said control system controls each of said phase shift, said firing frequency and said τₒₚₑₙ/τ_{cycle} ratio of said pulse detonation combustors based on at least one of a mass flow in said engine and a resonance in said engine, and
wherein said phase shift is greater than 0.0 and equal to or less than 1.0.

10. The engine of claim 1, wherein said control system controls each of said phase shift and said τₒₚₑₙ/τ_{cycle} ratio of said pulse detonation combustors based on at least one of a mass flow in said engine and a resonance in said engine, and
wherein said phase shift is greater than 0.0 and equal to or less than 1.0.

11. An engine, comprising:
a plurality of pulse detonation combustors;
a plurality of inlet valves, wherein each one of said plurality of pulse detonation combustors is coupled to a single inlet valve; and
a control system to control the operation of said pulse detonation combustors,
wherein said control system controls a phase shift and a τₒₚₑₙ/τ_{cycle} ratio of said pulse detonation combustors based on at least one of a mass flow in said engine and a resonance in said engine, where τₒₚₑₙ is the duration of time at least one of said valves is open during an operational cycle of at least one of said pulse detonation combustors and τ_{cycle} is the duration of time for said operational cycle, and
wherein said phase shift is greater than 0.0 and equal to or less than 1.0.

12. The engine of claim 11, wherein said controls system also controls a firing frequency of said pulse detonation combustors based on at least one of a mass flow in said engine and a resonance in said engine.

13. The engine of claim 1, wherein said control system operates said pulse detonation combustors such that the relationship 0.0<n*Φ≦1.0 is maintained during operation of the engine, where “n” is the number of said pulse detonation combustors and Φ is the ratio of τₒₚₑₙ/τ_{cycle}.

14. A method of operating an engine having a plurality of pulse detonation combustors, said method comprising:
directing a mass flow through said engine and into a plurality of pulse detonation combustors through a plurality of inlet valves; and
selecting at least one of a phase shift, a firing frequency and a τₒₚₑₙ/τ_{cycle} ratio of said pulse detonation combustors based on said mass flow,
where τₒₚₑₙ is the duration of time at least one of said valves is open during an operational cycle of at least one of said pulse detonation combustors and τ_{cycle} is the duration of time for said operational cycle.

15. The method of claim 14, further comprising determining an amount of mass flow in said engine and controlling at least one of said phase shift, said firing frequency and said τₒₚₑₙ/τ_{cycle} ratio based on said determined mass flow.

16. The method of claim 14, wherein said phase shift is controlled such that it is greater than 0.0 and equal to or less than 1.0.

17. The method of claim 14, further comprising operating said pulse detonation combustors such that the relationship 0.0<n*Φ≦1.0 is maintained during operation of the engine, where “n” is the number of said pulse detonation combustors and Φ is the ratio of τₒₚₑₙ/τ_{cycle}.

18. The method of claim 14, further comprising determining an amount of mass flow in said engine and a resonance of said engine and determining at least one of said phase shift, said firing frequency and said τₒₚₑₙ/τ_{cycle} ratio based on said determined mass flow and said resonance.

19. The method of claim 14, further comprising controlling the operation of said plurality of pulse detonation combustors such that no directly adjacent pulse detonation combustors are operated sequentially.

20. The method of claim 14, wherein each of said phase shift, said firing frequency and said τₒₚₑₙ/τ_{cycle} ratio of said pulse detonation combustors is determined based on at least one of said mass flow in said engine and a resonance in said engine, and
wherein said phase shift is greater than 0.0 and equal to or less than 1.0.
